(19) United States
(12) Patent Application Publication
(10) Pub. No.: US 2005/0014112 A1
(43) Pub. Date: Jan. 20, 2005

(54) Sacred geometry educational entertainment system

(76) Inventor: Warren Scott Fentress, Brookfield, CT (US)

Correspondence Address: ALTMAN & MARTIN, 6 BEACON ST, STE 600, BOSTON, MA, 02108, US

(21) Appl. No.: 10/678,764

(22) Filed: Oct. 6, 2003

Related U.S. Application Data
(60) Provisional application No. 60/445,770, filed on Apr. 3, 2003.

(51) Int. Cl. G09B 23/02; A63H 33/04; G09B 23/04

(52) U.S. Cl. 434/211

(57) ABSTRACT

Methods, devices and systems for teaching, learning and understanding sacred geometry concepts through magnetic modular toys comprising a plurality of triangular modular members assembled to form multidimensional hedrons and where in each triangular member includes a magnet such that adjacent members have opposite magnetic polarity facing each triangular member. Platonic solid shapes with interior magnets to hold forms together for construction of larger Platonic solids, geometry learning, and puzzle solving skills. Multidimensional hedrons include simple and small as ell as stellated tetrahedrons, octahedrons, icosahedrons and dodecahedrons.

### RELATED DOCUMENT

This application is based on provisional application Ser. No. 60/445,770 filed Feb. 10, 2003 then entitled, “Sacred Geometry Devices” by the same inventor and the applicant hereby claims priority there from.

### BACKGROUND

This invention relates generally to sacred geometry. More particularly it relates to methods, devices and systems for teaching, learning and understanding sacred geometry concepts. Even more particularly sacred geometry devices of this invention comprise magnetic learning toys.

The Problem

The problem with prior art sacred geometry devices is that they are not suitable for teaching abstract concepts in an entertaining and student friendly manner. Prior art toys and devices are not holistic as they do not involve and benefit body mind and spirit of children and adults both indoors and outdoors. Problems with prior games and toys can be categorized into the following:
a) Not suitable for abstract concepts
b) Challenging to children or adults but not both
c) Not cost effective, Not entertaining.
d) Do not harmonize with the environment.
e) Do not totally engage or involve the students
f) Educational or entertaining but seldom both.
g) Not student friendly, nor conducive to self teaching.

### SUMMARY

Sacred Geometry is the description given to the properties of systems that maintain the relationship of the circle to the triangle, and the tetrahedron to the sphere, as well as spiral functions like Fibonacci's number, the Golden section (PI and Phi ratios) and fractal algorithms. It also includes the body of Platonic solids and the principles of applied synergetics (from R. Buckminster Fuller's work).

The invention described below is the application of the 4D coordinate system defined by the tetrahedron of sacred geometry and the recursion of self-similar forms from fractal mathematics to the physical world in a toy product and a loudspeaker system.

### PRIOR ART

A preliminary limited prior art search was conducted. Furthermore the inventor is intimately familiar with the prior art. Following are typical examples of the prior art known to the applicant arranged in the ascending order of the reference numerals for ready reference of the reader.
a) U.S. Pat. No. 6,431,936 B1 presented to Chizuko Kiribuchi of Tokyo Japan on Aug. 13, 2002 for “Building Toy”
b) U.S. Pat. No. 5,826,872 issued to Albert Hall of Davie Fla. on Oct. 27, 1998 for “Spherical Puzzle Game and Method”
c) U.S. Pat. No. 5,651,715 bestowed upon Randall Shedelbower of Baldwin Mo. on Jul. 29, 1997 for “Geometric Toy”
d) Polydron Construction Toy based on '936 manufactured by Polydron International Ltd, Kemble, Glos, England GL7 6BA PH: 1-800-452-9978 Web site: http://www.polydron.co.uk/cgi-bin/index.cgi?currencv=dollars
e) Tetra Puzzle by Design Science Toys Web site:
http://www.dstovs.com/TR.html
f) Roger's Connection by design science Toys
Web site: http://www.dstoys.com/RC.html

None of the prior art devices known to the applicant or his attorney disclose the EXACT embodiment of this inventor that constitutes a simple, elegant, quick, convenient, affordable and fun toy for teaching, learning and understanding sacred geometry concepts.

Objectives

Unfortunately none of the prior art devices singly or even in combination provide for all of the objectives as established by the inventor for this system as enumerated below.

1. It is an objective of this invention to provide methods, devices and systems for teaching, learning and understanding sacred geometry concepts.

2. Another objective of this invention is to provide a game that involves engages and challenges both children and adults.

3. Another objective of this game is that it be suitable for playing indoors as well as out doors.

4. Another objective of this game is that it be both educational and entertaining.

5. Another objective of this game is that it be aesthetic and elegant design that integrates harmoniously with any environment.

6. Another objective of this game is that it be holistic to involve and benefit body, mind and spirit.

7. Another objective of this invention is that it be student friendly and self teachable.

8. Another objective of this game is that its use is quick, simple, convenient and easy.

9. Another objective of this invention is that it be suitable for all types of users in all types of weather conditions.

10. Another objective of this invention is that the devices, processes and system of this invention be portable.

11. Another objective of this invention is that its design is simple and even elegant.

12. Another objective of this invention is that its use is intuitive which requires no further training.

13. Another objective of the game of this invention is that it be capable of multiple uses.

14. Another objective of this invention is that it use little or no additional energy.

15. Another objective of this invention is that the invention use modular standard components easily interface-able transportable and storable.

16. Another objective of this invention is that it be reliable such that it practically never fails and requires little or no maintenance.

17. Another objective of this invention is that it be environmentally friendly and use biodegrade materials to the extent practical.

18. Another objective of this invention is that it be physically safe in normal environment as well as accidental situations.

19. Another objective of this invention is that it be long lasting made from durable material.

20. Another objective of this invention is that it meet all federal, state, local and other private standards guidelines, regulations and recommendations with respect to safety, environment, energy consumption.

21. Another objective of this invention is that it not compromise the safety or the comfort of the user.

22. Another objective of this invention is that it be suitable for gift giving.

23. Another objective of this invention is that it be suitable for promotional give always complete with message of the sponsor such as a union, casino or charitable organization.

24. Another objective of this invention is that it be capable of teaching sacred geometry concepts in two and three dimensions.

25. Other objectives of this invention reside in its simplicity, elegance of design, ease of manufacture, service and use and even aesthetics as will become apparent from the following brief description of the drawings and the detailed description of the concept embodiment.

Unfortunately none of the prior art devices singly or even in combination provide all of the features established by the inventor for this system e.g. to teach sacred geometry concepts in 2D and 3D in student friendly holistic manner that is safe cost effective and fun.

Although there are toys on the market that embody elements of Platonic solids and polyhedral forms, there are no Platonic solids with colored, magnetized faces that are polarized in the arrangement noted in this design. Since the pieces can be joined in a limitless amount (along the lines of how Lego-brand building blocks can be snapped together ad-infinitum), there is no end to the imaginative possibilities one might discover.

Since the magnets are embedded, the faces will be able to join smoothly and rotate around one another, which provides ease-of-use for the task of aligning the colored faces. The only similarity to prior art inventions is the use of magnets for joining construction elements, and in the general polyhedron shapes—there are no products that use a solid plastic, polarity-colored shape and embedded magnets.

### BRIEF DESCRIPTION OF THE DRAWINGS

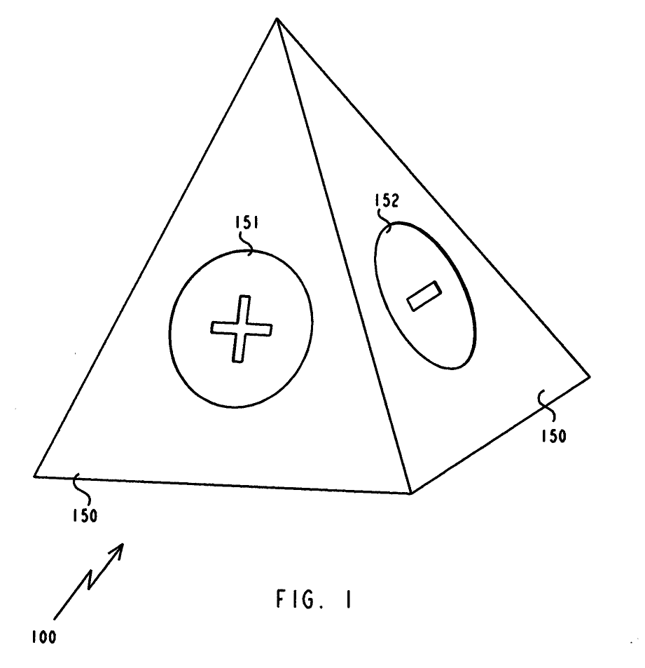

a) FIG. 1 shows an isometric 3D view of a tetrahedron with magnets of alternate polarity on adjacent members.

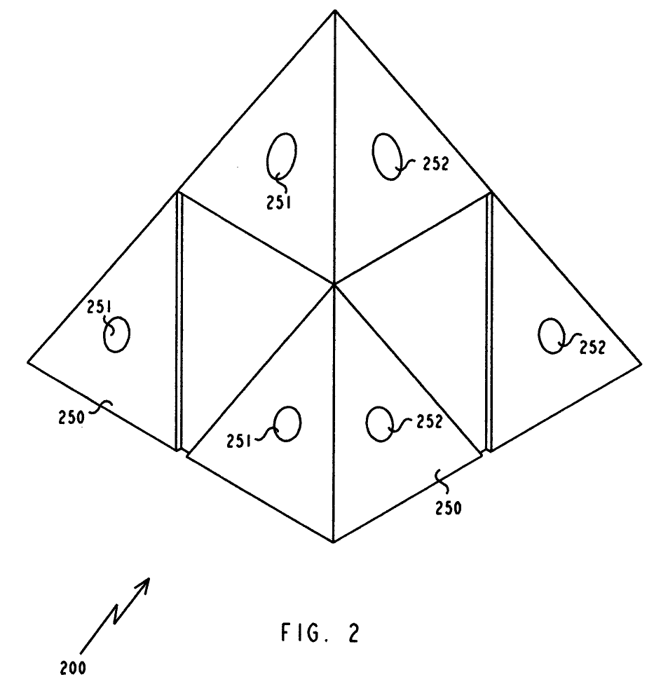

b) FIG. 2 shows an isometric 3D view of a modular tetrahedron with magnets of alternate polarity on adjacent members.

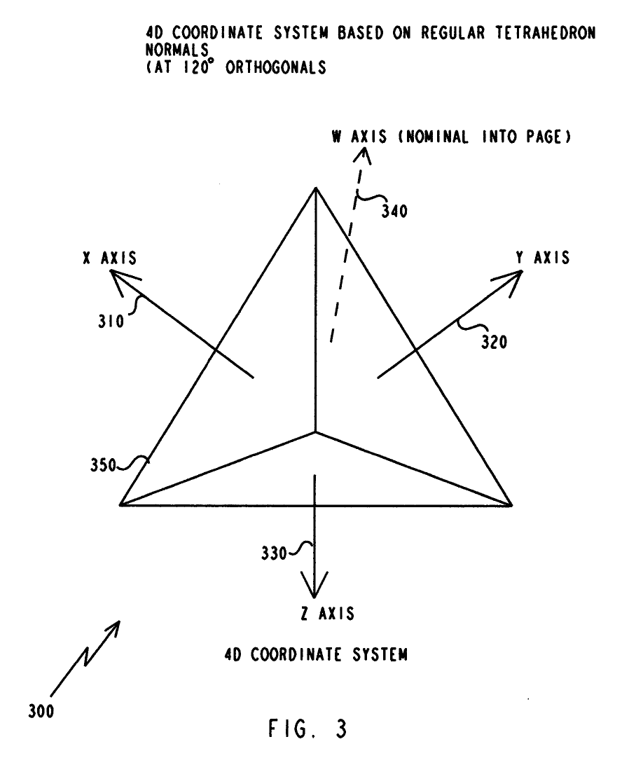

c) FIG. 3 shows plan view of the four dimensional coordinate system.

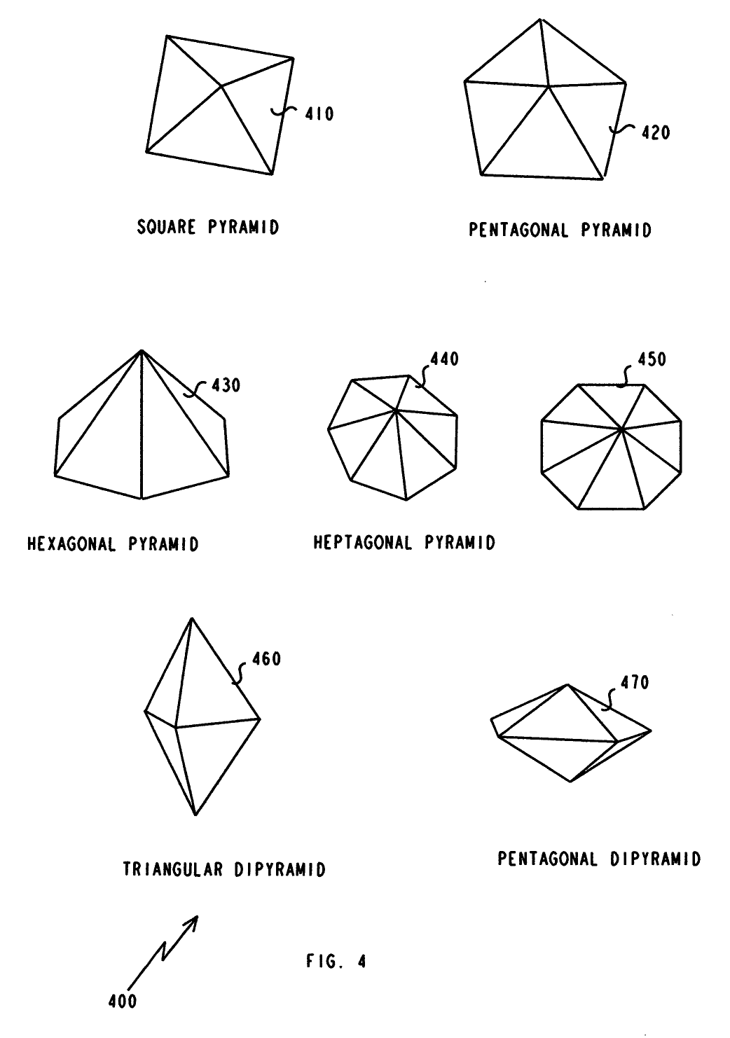

d) FIG. 4 shows various forms of mono and dipyramids.

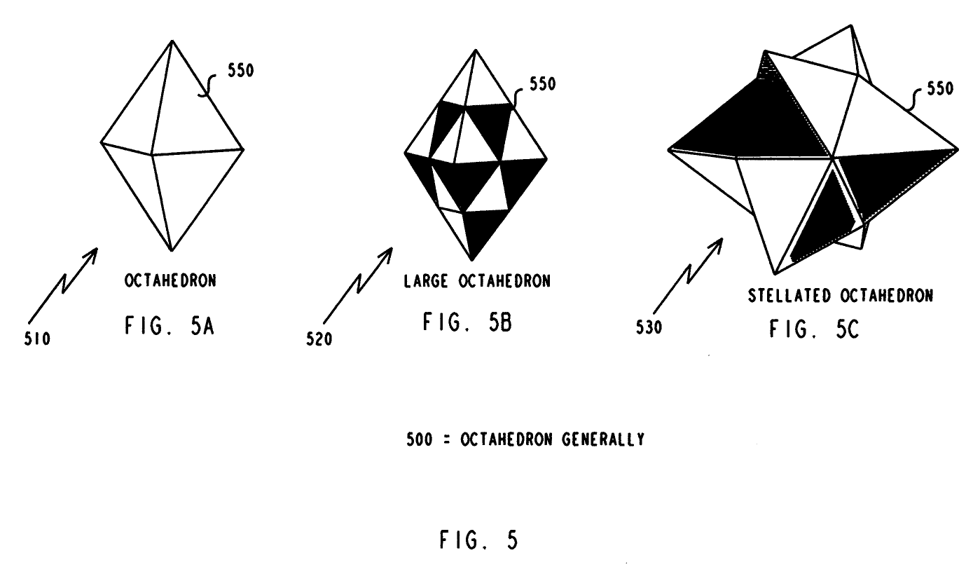

e) FIG. 5A shows a small octahedron and FIG. 5B shows a large octahedron and FIG. 5C shows a Stellated octahedron.

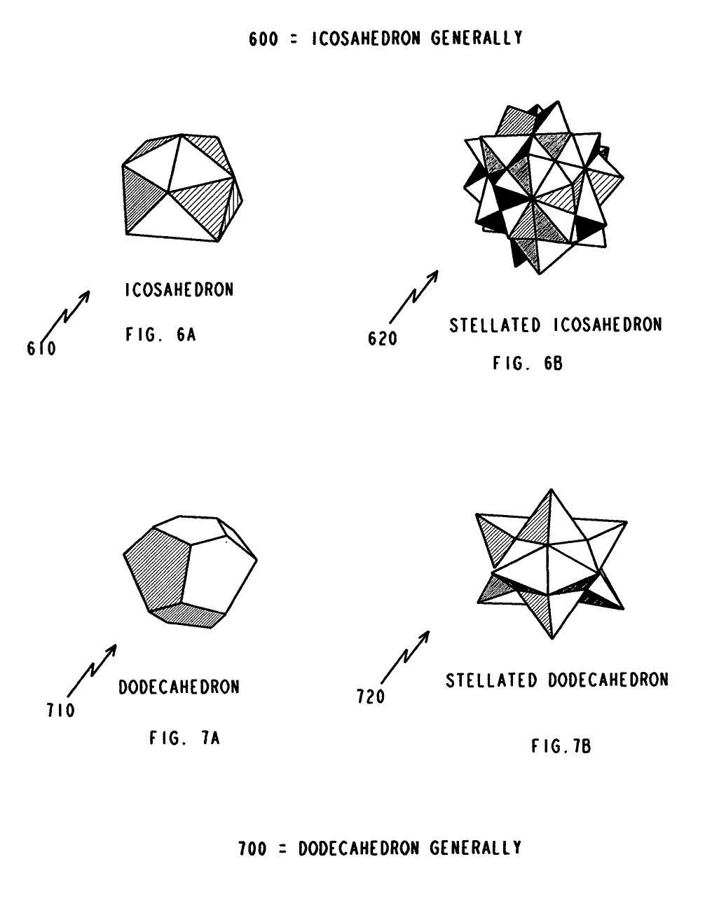

f) FIG. 6A shows an Icosahedron and FIG. 6B shows a stellated Icosahedron.

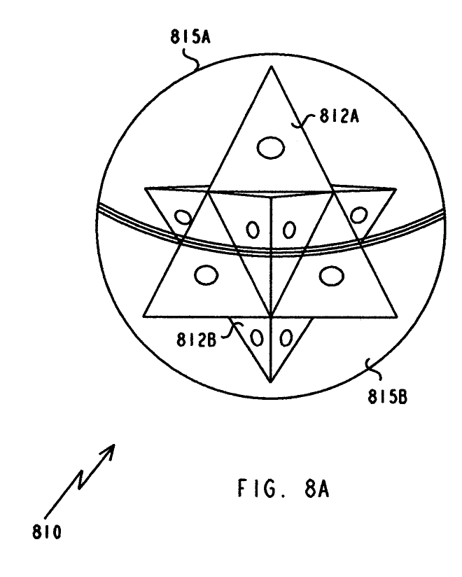

g) FIG. 7A shows a Dodecahedron and FIG. 7B shows a stellated dodecahedron.

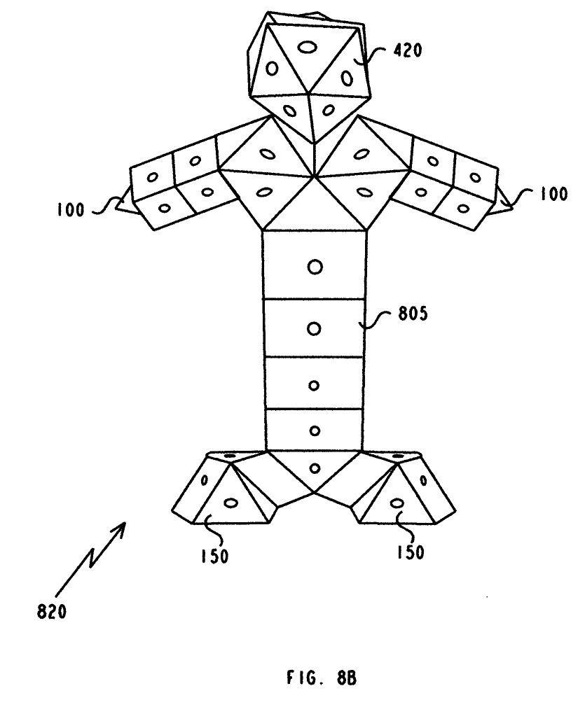

h) FIG. 8A shows a front plan view of an assembled configuration inside a transparent sphere.

i) FIG. 8B shows front plan view of an assembled humanoid toy configuration

### DETAILED DESCRIPTION OF THE BEST MODE PREFERRED EMBODIMENT

As shown in the drawings wherein like numerals represent like parts throughout the several views, there is generally disclosed in FIG. 1 an isometric 3D view of a tetrahedron with magnets of alternate polarity 151, 152 on adjacent members 150.

FIG. 2 shows an isometric 3D view of a modular tetrahedron with magnets of alternate polarity 251, 252 on adjacent members 250. There is no theoretical limit to the size of the tetrahedron but of course there are practical limits of logistics.

FIG. 3 shows plan view of the four dimensional coordinate system. Through the application of a 4D tetra system, which is a planar coordinate system based on a regular tetrahedron (see diagram below), systems can be constructed that follow natural principles.

The tetrahedron is a planar approximation of a sphere with the minimum number of faces. Devices that require spherical output through rectilinear transducers can use the tetra system to achieve the desired result.

Another quality of the tetrahedron and sacred geometry is in the repeating patterns of symmetry found as the Platonic solids are joined. This property is the three-dimensional equivalent of fractal mathematics where self-similar structures are multiplied to produce computer graphics.

In the natural world, solids are manifested through the recursion of the basic sacred geometry forms. These forms are polarized, which determines how the fundamental forms (tetrahedron, pyramid, Platonic solids) may be joined to produce larger similar structures.

Instead of the tetrahedron, pyramids may be assembled from the same basic triangular members. Examples of pyramids include square, pentagonal hexagonal, heptagonal, octagonal etc.

FIG. 4 shows various forms of mono and dipyramids 400. These forms become the primary building blocks, which can be combined to form other Platonic and Johnson Solids, including the stellated variations.

Included in FIG. 4 are Square Pyramid (410), Pentagonal Pyramid (420) Hexagonal pyramid (430) Heptagonal pyramid (440) Octagonal pyramid (450) Triangular Dipyramid (460) and Pentagonal Dypyramid (470) FIG. 5A shows a small octahedron 510 which in turn comprises a pair of tetrahedron 550 or square pyramids 410 and FIG. 5B shows a large octahedron 520 which comprises plurality of pieces or blocks 550 disclosed earlier and FIG. 5C shows a Stellated octahedron 530 also made from smaller and modular blocks 550 disclosed.

FIG. 6A shows an Icosahedron 610 and FIG. 6B shows a stellated Icosahedron 620. Likewise FIG. 7A shows a Dodecahedron 710 and FIG. 7B shows a stellated dodecahedron 720. FIG. 8A shows a front plan view of an assembled configuration comprising plurality of elements 812 disclosed earlier, housed inside a transparent sphere 815 which in turn comprises two transparent hemispheres 815A & 815B. FIG. 8B shows front plan view of an assembled humanoid toy configuration 820 comprising plurality of other elements such as head 420, arms 100, upper body member 430, lower body member 805 and legs and feet 150.

Assembly Use and Operation

The manufacturing, assembly and use of this invention is very simple even intuitive. The toy is a set of basic building blocks that follow principles of sacred geometry. The toy is comprised of Platonic solids with colored, magnetized faces with a specific polarity so that the various solids may be joined together to form more complex shapes and color patterns. As the shapes combine to create larger related forms, the relationship between the basic geometrical forms and the bipolar forces needed to hold the objects in each configuration provide a learning experience of spatial visualization, problem solving, iteration, and symmetry.

The toy is designed to teach the concepts of polyhedra, the Johnson and Platonic solids, Sacred Geometry, pattern recognition, polarity and symmetry. Through visualization and tactile exploration, the pieces are assembled to match existing shapes, or to find new arrangements. For the puzzle attribute, the goal is to align the pieces in such a way as to obtain symmetrical alternating color patterns (shown in the pictures above).

In the preferred embodiment the inventor employed toy members approximately 2″ on a side, making it easy to manipulate even for young children. The sensation of two pieces snapping together from the magnetic attraction provides sensory feedback, fascination and amusement.

In the best mode preferred embodiment the inventor made the parts by embedding neodymium disk magnets in injection molded parts.

The Basic Solids include polyhedra from the Platonic Solids. The basic shapes that are part of the Toy include the regular tetrahedron, pyramid, pentagonal pyramid, hexagonal pyramid and heptagonal pyramid. All members are modular such that two large tetrahedrons may be joined back to back to form one large octahedron.

The inventor has given a non-limiting description of the drop case rapid weapon deployment system of this invention. Due to the simplicity and elegance of the design of this invention designing around it is very difficult if not impossible. Nonetheless many changes may be made to this design without deviating from the spirit of this invention. Examples of such contemplated variations include the following:

1. The shape and size and quantity of the various members and components may be modified.

2. The color, aesthetics and materials may be enhanced or varied.

3. Different educational graphic may be selected for learning and teaching different substantive subjects through this medium of instruction.

4. Additional complimentary and complementary functions and features may be added.

5. A more economical version of the game be adapted.

6. An audio-visual computer software version of the game may be employed.

7. Additional educational content may be imparted on the faces of the hedrons.

8. Devices such as lights, speakers etc may be added in hedrons for special effects.

9. The fastener means may be modified. For example One might also construct similar pieces through the use of foam core with affixed magnets.

10. Another alternative is to use polarized solid state connectors instead of magnets, like Velcro ‘hooks and rings’, or a snap connector with a male/female plug.

NOTE: The Velcro doesn't have the rotation capability of the magnets, but a swivel device could be added to address that.

Thus the game is not limited to a single toy shape or tetrahedron. The shapes can be substituted for colors, numbers, letters, animal figures, images, patterns and more. It can have a version where it is played in the swimming pool and at night where glow in the dark material or other illuminating devices are used. For added enhancement color lights and even motion may be added. This game can also have a software program version where the user can have the ability to customize the images to be used on the game. Thus it can not only teach sacred geometry concepts but also other substantive knowledge in almost any medium of instruction.

Other changes such as aesthetics and substitution of newer materials as they become available, which substantially perform the same function in substantially the same manner with substantially the same result without deviating from the spirit of the invention may be made.

Following is a listing of the components used in the best mode preferred embodiment and the alternate embodiments for use with OEM as well as retrofit markets. For the ready reference of the reader the reference numerals have been arranged in ascending numerical order.

| | |
|---|---|
| 100 = | Tetrahedron generally |
| 150 = | Triangular member of a tetrahedron |
| 151 = | Magnet of negative or south pole facing the triangular member |
| 152 = | Magnet of positive or south pole facing the triangular member |
| 200 = | large modular tetrahedron generally |
| 250 = | Large modular tetrahedron triangular member, wherein |
| | adjacent triangular members bear opposite magnetic polarity. |
| 251 = | Magnet of first polarity |
| 252 = | Magnet of second polarity. |
| 300 = | 4D coordinate system generally |
| 310 = | X (1^{st}) Axis of 4D coordinate system |
| 320 = | Y (2^{nd}) Axis of 4D coordinate system |
| 330 = | Z (3^{rd}) Axis of 4D coordinate system |
| 340 = | W (4^{th}) Axis of 4D coordinate system |
| 400 = | Modular pyramids generally |
| 410 = | Square Pyramid |
| 420 = | Pentagonal Pyramid |
| 430 = | Hexagonal pyramid |
| 440 = | Heptagonal pyramid |
| 450 = | Octagonal pyramid |
| 460 = | Triangular Dipyramid |
| 470 = | Pentagonal Dypyramid |
| 500 = | Octahedrons generally |
| 510 = | Simple & smallest basic Octahedron |
| 520 = | Large octahedron |
| 530 = | Stellated octahedron |
| 550 = | Triangular members of octahedron |
| 600 = | Icosahedron generally |
| 610 = | Simple & smallest basic Icosahedron |
| 620 = | Stellated Icosahedron |
| 700 = | Dodecahedron generally |
| 710 = | Simple & smallest basic dodecahedron |
| 720 = | Stellated dodecahedron |
| 805 = | Humanoid lower body |
| 810 = | Toy TOP in a transparent sphere |
| 812 = | Symmetrical half section of toy TOP |
| 815 = | Transparent hemisphere |
| 820 = | Humanoid |

Definitions and Acronyms

A great care has been taken to use words with their conventional dictionary definitions. Following definitions are included here for clarification.

| | |
|---|---|
| 3D = | Three Dimensional |
| 4D = | Four Dimensional |
| DIY = | Do It Yourself |
| Holistic = | Engaging body, brain and soul. |
| Integrated = | Combination of two entities to act like one |
| Interface = | Junction between two dissimilar entities |
| Octahedron = | Eight sided hedron |
| Icosahedron = | Ten sided embodiment |
| Dodecahedron = | Twelve sided object |
| OEM = | Original Equipment Manufacturer |

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

1-20. (Cancelled)

21. A three-dimensional toy building block comprising:
a. a polyhedron with faces;
b. each of said faces having one magnetic region with a first polarity or a second polarity, and
c. each of said faces being a first color or a second color, said first color corresponding to said first polarity and said second color corresponding to said second polity.

22. The block of claim 21 wherein said magnetic region is cantered in said face.

23. The block of claim 21 wherein said magnetic region is provided by a magnet embedded in said face.

24. The block of claim 21 wherein said block is a platonic solid.

25. The block of claim 21 wherein said block is a regular tetrahedron.

26. The block of claim 25 wherein a first and second of said faces are said first polarity and a third and fourth of said faces are said second polarity.

27. A three dimensional toy building block comprising:
a. a regular tetrahedron with four faces;
b. each of said faces having one magnetic region provided by a magnet embedded in said face, said magnetic region being centered in said face, said magnetic region of a first and second of said faces having a first polarity, and said magnetic region of a third and fourth of said faces having a second polarity; and
c. said first face and said second face being a first color and said third face and said fourth face being a second color, whereby said first color corresponds to said first polarity and said second color corresponds to said second polarity.
